(19) United States
(12) Patent Application Publication
(10) Pub. No.: US 2023/0049679 A1
(43) Pub. Date: Feb. 16, 2023

(54) FLASH LIGHT DETECTION AND RANGING SYSTEM HAVING ADJUSTABLE FIELD OF VIEW

(71) Applicant: Beijing Voyager Technology Co., Ltd., Beijing (CN)

(72) Inventors: Chao Wang, Mountain View, CA (US); Yonghong Guo, Mountain View, CA (US); Wenbin Zhu, Mountain View, CA (US); Lingkai Kong, Mountain View, CA (US)

(21) Appl. No.: 17/393,755

(22) Filed: Aug. 4, 2021

(51) Int. Cl. G01S 7/481; G01S 7/484; G01S 17/931; G01S 7/4911; G01S 7/4863

(52) U.S. Cl. CPC G01S 7/4817; G01S 7/484; G01S 17/931; G01S 7/4911; G01S 7/4863

(57) ABSTRACT

In some examples, an apparatus is provided. The apparatus comprises: an illuminator having an adjustable field of view (FOV), the FOV being adjusted based on setting a direction of propagation of light to illuminate the FOV; a light detector; and a controller configured to: control the illuminator to project the light along a first direction of propagation to illuminate a first FOV; control the illuminator to project the light along a second direction of propagation to illuminate a second FOV; detect, using the light detector, reflected light received from the first FOV and the second FOV to generate one or more detection outputs for a combined FOV including the first FOV and the second FOV; and perform at least one of a detection operation or a ranging operation of an object in the combined FOV based on the one or more detection outputs.

### BACKGROUND

Light detection and ranging (LiDAR) typically refers to a method/system for measuring distances by illuminating a target with light, such as laser light, and measuring the time the reflected light takes to return the sensor. A time difference between the transmission time of the light and the detection time of the reflected light can be used to measure a distance between the LiDAR system and the target.

There are various types of LiDAR systems. One type of LiDAR is a flash LiDAR. A flash LiDAR can illuminate the entire field of view (FOV) with a wide diverging laser beam in a single pulse. A detector, which can include a one-dimensional (1-D) or two-dimensional (2-D) array of photodetectors, can then detect reflected beam from different points within the FOV. Each photodetector can generate a detection output for measuring a time difference between the single pulse and the reflected light from a point in the field of view, and a 1-D or 2-D distribution of depths can be obtained.

It is desirable for LiDAR system to be able to illuminate a wide FOV over a long distance, which allows the LiDAR system to illuminate and detect more objects, and perform ranging operations, within a large scene and over a long detection distance. But FOV and detection distance can require a trade-off such that a large FOV may lead to a short detection distance, and vice versa.

### BRIEF SUMMARY

In some examples, an apparatus, which can be part of a Light Detection and Ranging (LiDAR) module of a vehicle, comprises: an illuminator having an adjustable field of view (FOV), the FOV being adjusted based on setting a direction of propagation of light to illuminate the FOV; a light detector; and a controller configured to: control the illuminator to project the light along a first direction of propagation to illuminate a first FOV; control the illuminator to project the light along a second direction of propagation to illuminate a second FOV; detect, using the light detector, reflected light received from the first FOV and the second FOV to generate one or more detection outputs for a combined FOV including the first FOV and the second FOV; and perform at least one of a detection operation or a ranging operation of an object in the combined FOV based on the one or more detection outputs.

In some aspects, the illuminator is configured to: illuminate the first FOV with a first divergent light beam that carries a first single pulse; and illuminate the second FOV with a second divergent light beam that carries a second single pulse.

In some aspects, the detector comprises an array of sensors.

In some aspects, the first FOV and the second FOV spans different ranges along at least one of a vertical axis or a horizontal axis.

In some aspects, the illuminator comprises one or more light sources and one or more light reflecting surfaces. The one or more light sources are configured to project the light to the one or more light reflecting surfaces. The one or more light reflecting surfaces are configured to reflect the light at a first angle of reflection and a second angle of reflection with respect to one or more normal axes of the one or more light reflecting surfaces to illuminate, respectively, the first FOV and the second FOV.

In some aspects, the one or more light reflecting surfaces comprises a first light reflecting surface having a first normal axis and a second light reflecting surface having a second normal axis.

In some aspects, the first light reflecting surface and the second light reflecting surface form a continuous curved light reflecting surface.

In some aspects, the one or more light sources comprise a single light source. The controller is configured to: within a first time, cause the single light source to project the light onto the first light reflecting surface to illuminate the first FOV; and within a second time, cause the single light source to project the light onto the second light reflecting surface to illuminate the second FOV.

In some aspects, the first light reflecting surface and the second light reflecting surface are, respectively, a first surface and a second surface of a polygon. The apparatus further comprises an actuator configured to rotate the polygon. The controller is configured to: at the first time, rotate, using the actuator, the polygon by a first rotation angle such that the first light reflecting surface faces the single light source; and at the second time, rotate, using the actuator, the polygon by a second rotation angle such that second light reflecting surface faces the single light source.

In some aspects, both the first surface and the second surface are flat surfaces. The polygon is rotatably mounted on a third surface. When the polygon is rotated by the first rotation angle, the first surface forms a first slope angle with a first axis of the third surface. When the polygon is rotated by the second rotation angle, the second surface forms a single slope angle with the first axis of the third surface.

In some aspects, at least one of the first surface or the second surface comprises a curved surface, such that the first FOV and the second FOV have different ranges along a horizontal axis parallel with the third surface.

In some aspects, the one or more light sources comprise a first light source facing the first light reflecting surface and a second light source facing the second light reflecting surface.

In some aspects, the controller is configured to enable the first light source and the second light source to illuminate, respectively, the first FOV via the first light reflecting surface and the second FOV via the second light reflecting surface simultaneously.

In some aspects, the one or more light sources comprise a single light source. The one or more light reflecting surface comprise a single mirror. The apparatus comprises an actuator configured to set an orientation of the single mirror. The controller is configured to: set a first orientation of the single mirror using the actuator; cause the single light source to project light to the single mirror at the first orientation to illuminate the first FOV; set a second orientation of the single mirror using the actuator; and cause the single light source to project light to the single mirror at the second orientation to illuminate the second FOV.

In some aspects, the illuminator comprises a light source connected to one or more actuators, and a light reflecting surface. The controller is configured to: control the one or more actuators to tilt the light source at a first angle to project the light to the light reflecting surface at a first direction to illuminate the first FOV; and control the one or more actuators to tilt the light source at a second angle to project the light to the light-reflecting surface at a second direction to illuminate the second FOV.

In some aspects, the controller is configured to, within a first time: control the illuminator to illuminate the first FOV; and detect, using the light detector, reflected light received from the first FOV to generate a first detection output of the one or more detection outputs. The controller is also configured to, within a second time: control the illuminator to illuminate the second FOV; and detect, using the light detector, reflected light received from the second FOV to generate a second detection output of the one or more detection outputs. The controller is further configured to generate a combined detection output for the combined FOV based on combining the first detection output and the second detection output.

In some aspects, the controller is configured to: within a first time, control the illuminator to illuminate the first FOV; within a second time, control the illuminator to illuminate the second FOV; and after the first time and the second time, detect, using the light detector, reflected light received from the first FOV and the second FOV to generate a combined detection output for the combined FOV.

In some examples, a method comprises: controlling an illuminator to project light along a first direction of propagation to illuminate a first FOV; controlling the illuminator to project the light along a second direction of propagation to illuminate a second FOV; detecting, using a light detector, reflected light received from the first FOV and the second FOV to generate one or more detection outputs for a combined FOV including the first FOV and the second FOV; and performing at least one of a detection operation or a ranging operation of an object in the combined FOV based on the one or more detection outputs.

In some aspects, the light comprises a divergent light beam that carries a single pulse. The detector comprises an array of sensors.

In some aspects, the illuminator comprises a polygon having multiple light reflecting surfaces, each light reflecting surface being associated with a FOV. The first FOV and the second FOV are illuminated based on rotating the polygon.

### BRIEF DESCRIPTION OF THE DRAWINGS

The detailed description is set forth with reference to the accompanying figures.

FIG. 1 shows an autonomous driving vehicle and a LiDAR system utilizing aspects of certain examples of the disclosed techniques herein.

FIG. 2A, FIG. 2B, and FIG. 2C illustrate examples of various types of LiDAR systems and their operations.

FIG. 3A, FIG. 3B, and FIG. 3C illustrate examples of a LiDAR system having an adjustable field of view (FOV), according to examples of the present disclosure.

FIG. 4 illustrates examples of internal components of the LiDAR system of FIG. 3A-FIG. 3C to provide adjustable FOV, according to examples of the present disclosure.

FIG. 5A, FIG. 5B, FIG. 5C, and FIG. 5D illustrate examples of internal components of the LiDAR system of FIG. 3A-FIG. 3C to provide adjustable FOV, according to examples of the present disclosure.

FIG. 6A and FIG. 6B illustrate examples of internal components of the LiDAR system of FIG. 3A-FIG. 3C to provide adjustable FOV, according to examples of the present disclosure.

FIG. 7A and FIG. 7B illustrate examples of an imaging operation supported by the LiDAR system of FIG. 3A-FIG. 3C, according to examples of the present disclosure.

FIG. 8 illustrates a method of operating a LiDAR system, according to examples of the present disclosure.

FIG. 9 illustrates an example computer system that may be utilized to implement techniques disclosed herein.

### DETAILED DESCRIPTION

In the following description, various examples of a LiDAR system will be described. For purposes of explanation, specific configurations and details are set forth to provide a thorough understanding of the examples. However, it will be apparent to one skilled in the art that certain examples may be practiced or implemented without every detail disclosed. Furthermore, well-known features may be omitted or simplified to prevent any obfuscation of the novel features described herein.

LiDAR typically refers to a method/system for measuring distances by illuminating a target with light, such as laser light, and measuring the time the reflected light takes to return the sensor. A time difference between the transmission time of the light and the detection time of the reflected light can be used to measure a depth of the target from the LiDAR system. LiDAR can be found in many applications, such as in vehicles where the LiDAR can detect obstacles (e.g., other vehicles, pedestrians) to assist drivers and/or to support autonomous driving.

There are various types of LiDAR systems. One type of LiDAR is a scanning LiDAR. A scanning LiDAR uses a collimated beam to illuminate a single point within a FOV at a time, and the beam is scanned according to a raster pattern to illuminate the entire FOV point-by-point. A point sensor can detect a reflected beam from each illuminated point within the field of view, and a time difference between the transmitted light and the reflected light (if any) from the point can be used to determine the depth of the point from the point sensor. Another type of LiDAR is a flash LiDAR. A flash LiDAR can illuminate the entire FOV with a wide diverging beam (e.g., a laser beam) in a single pulse. A detector, which can include a 1-D or 2-D array of photodetectors, can then detect reflected beam from different points within the field of view. Each photodetector can include one or more pixel cells to generate a detection output including one or more pixels. The pixels can be used to measure a time difference between the single pulse and the reflected light pulse from a point in the field of view, and a 1-D or 2-D distribution of depths can be obtained.

A flash LiDAR system can offer several advantages over a scanning LiDAR system. Specifically, by illuminating the entire FOV with a single laser pulse, the entire scene within the FOV can be imaged with a single laser flash. Such arrangements allow generation of an image in which each pixel is captured at the same time, which can avoid motion blurring in the image due to motion of the target subject. Addition, as each image can generated from a single illumination, rather than from a scanning pattern of illumination which takes a much longer time to complete, images of the target object can be produced at a higher frame rate. All these enable the flash LiDAR system to capture images of fast moving objects to support detection and ranging operations. This makes flash LiDAR ideal for applications that require fast response time, such as blind spot detections for a vehicle.

The performance of a LiDAR system can be evaluated based on various metrics, such as the ranges of FOV and detection distance. The FOV can define the extent of a scene to be detected and/or illuminated by the LiDAR system. A wider FOV means a larger extent of a scene can be imaged. Moreover, a longer detection distance means more distant objects can be detected and for which ranging operations can be performed. Both allow the LiDAR system to detect more objects in the surrounding and to provide more information about the environment the LiDAR system operates in. This is especially critical in a case where the LiDAR system supports the operation of a vehicle, given that the traffic conditions around the vehicle can be complex and fast changing. A driver, or an autonomous driving system, needs as much information about the surrounding as possible to maneuver the vehicle and to detect and avoid potential dangers created by other vehicles and/or pedestrians.

But FOV and detection distance can require a trade-off, especially in a case of flash LiDAR. Specifically, the maximum detection distance can be defined by the intensity of light projected by the LiDAR system due to the attenuation of the light as it travels over a distance. In the case of flash LiDAR, as the flash LiDAR illuminates the FOV with a divergent light beam, the energy of the light beam is distributed within the FOV. A larger FOV may require a higher beam divergence, which in turn reduces the intensity of light at each point within the FOV, as well as the detection distance. Therefore, a large FOV may lead to a short maximum detection distance, and vice versa. The intensity of light may be further reduced to avoid projecting high power layer to pedestrians/drivers at vicinity to improve safety. Such trade-offs can limit the application of flash LiDAR. For example, due to the short detection range, flash LiDAR is typically used in blind spot detection during a parking operation. It is desirable to have a flash LiDAR that can support both a large FOV and a long detection distance, so that more applications that require longer detection ranges, such as autonomous lane changing operations, or even full autonomous driving operations, can leverage the high performance of flash LiDAR in detecting fast moving objects.

### Conceptual Overview of Certain Examples

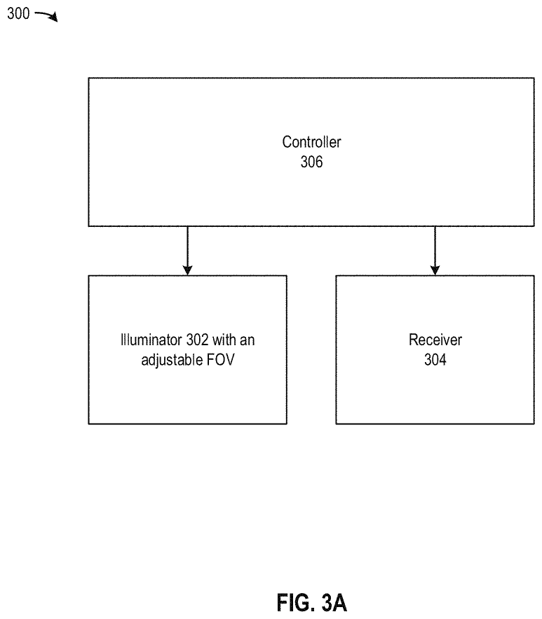

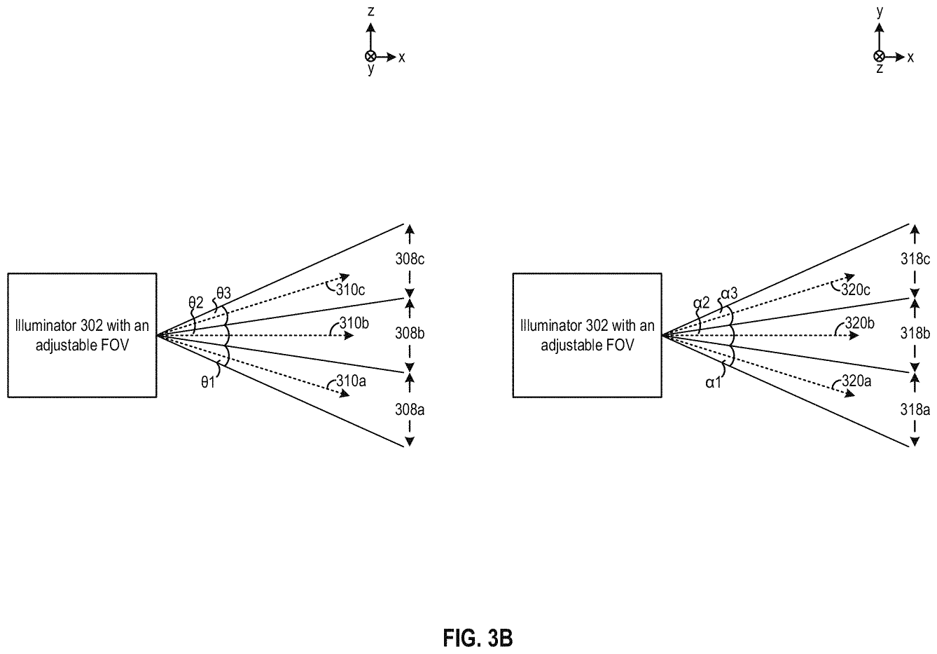

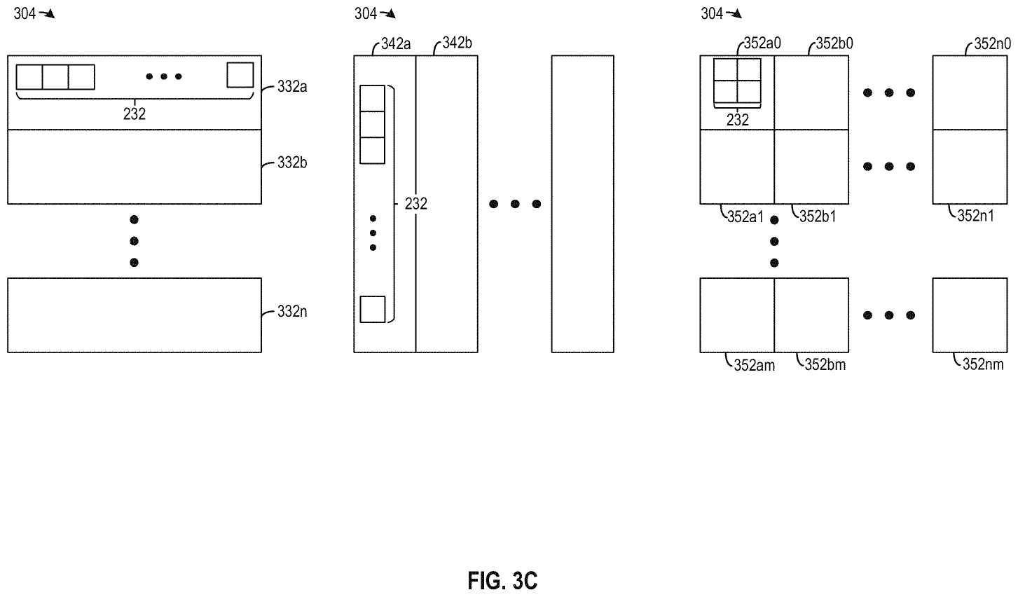

Examples of the present disclosure relate to a LiDAR system, such as a flash LiDAR, that can address the problems described above. Various examples of the LiDAR system and their operations are shown in FIG. 3A-FIG. 7. As shown in FIG. 3A, a LiDAR system can include an illuminator having an adjustable field of view (FOV), a receiver, and a controller to control the operations of the illuminator and the receiver. Referring to FIG. 3B, the controller can control the illuminator to illuminate multiple FOVs. Each FOV can span different ranges along a vertical axis and/or along a horizontal axis, and can be illuminated by light of a different propagation direction from the illuminator. The receiver can be controlled to generate one or more detection outputs for a combined FOV comprising the multiple FOVs. Based on the one or more detection outputs, the controller can perform a detection operation and/or a ranging operation for an object in the combined FOV.

In some examples, the illuminator and the receiver can be part of a flash LiDAR system. The illuminator can include one or more light sources controlled by the controller to illuminate each of the multiple FOVs with a divergent light beam, such as a divergent laser beam, that carries a single light pulse. Each FOV can be illuminated by a divergent light beam having a particular propagation direction from the illuminator. The receiver can include an array (1-D or 2-D) of photodetectors to detect light reflected from each illuminated FOV. As shown in FIG. 3C, the array of image sensors can be divided into sections, with each section corresponding to a particular FOV to be imaged by the illuminator.

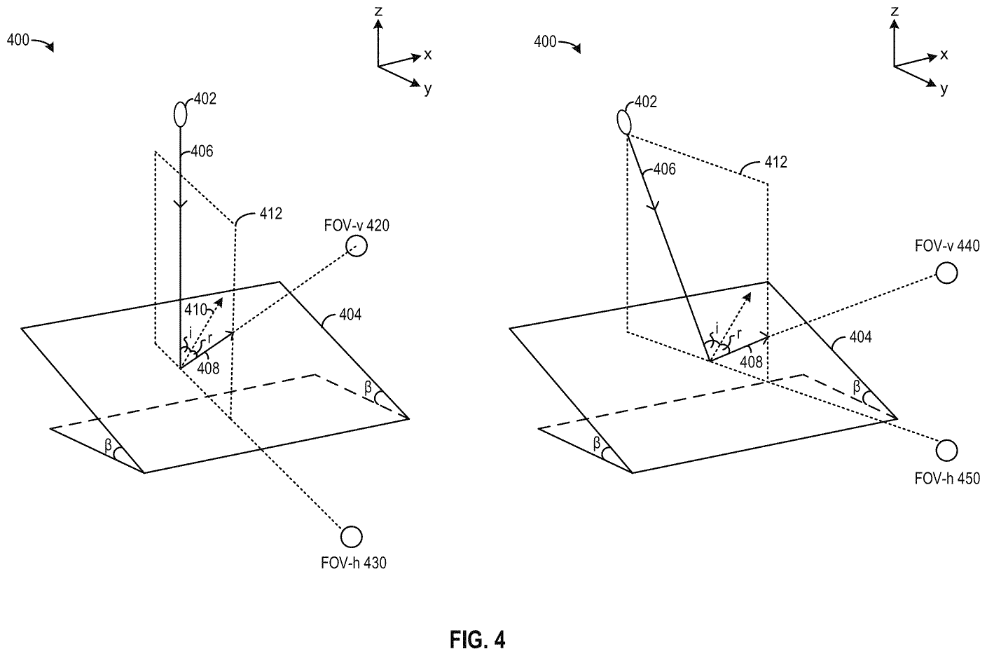

Referring to FIG. 4, the illuminator can include a light reflecting surface to reflect the incident light projected by a light source of the illuminator. The light reflecting surface can reflect the incident light at a particular angle of reflection, and the angle of reflection can set the FOV of the illumination. The angle of reflection can be determined based on a relative orientation of the normal axis of the light reflecting surface with respect to the incident path of the light. The relative orientation can be set based on, for example, a slope angle of the light reflecting surface, the orientation of the light reflecting surface, and/or a direction of projection of the incident light by the light source to the light reflecting surface. For example, referring to FIG. 4, the normal axis of the light reflecting surface and incident path can define a plane. The angle between the normal axis and the incident path on that plane can determine the angle of reflection of the incident light, and the reflected light also propagate on the plane. The angle of reflection of the incident light on the vertical plane can determine a vertical FOV along the z-axis. Moreover, the orientation of the plane (and the normal axis) on the x-y plane can also define a horizontal FOV on the x-y plane.

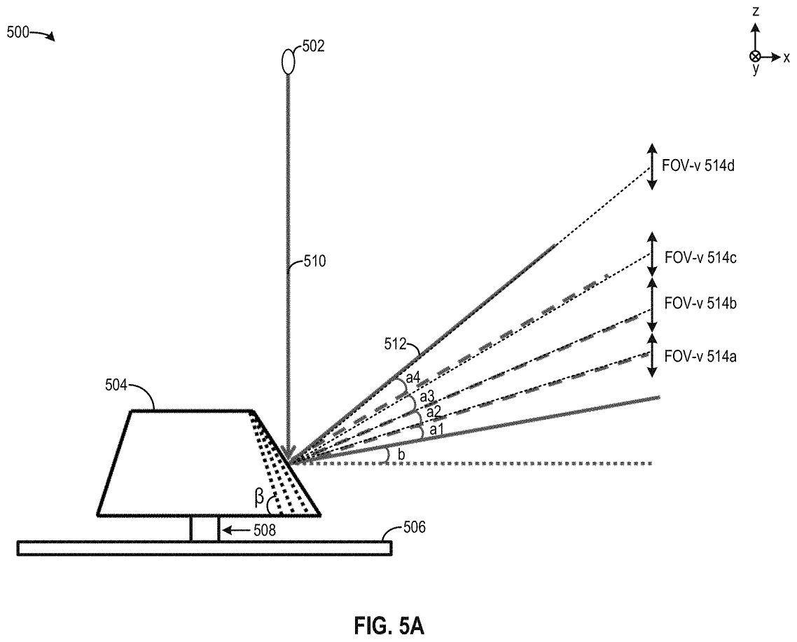

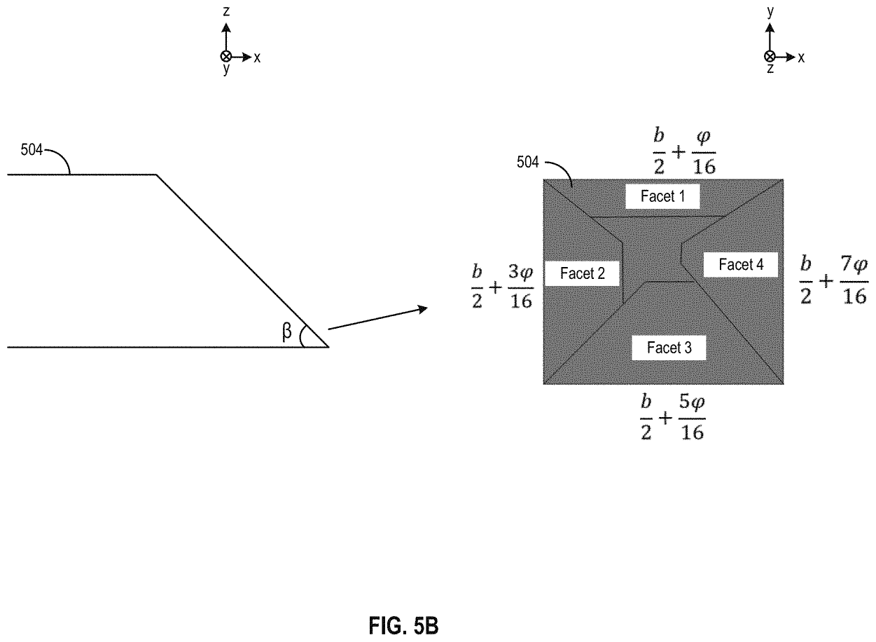

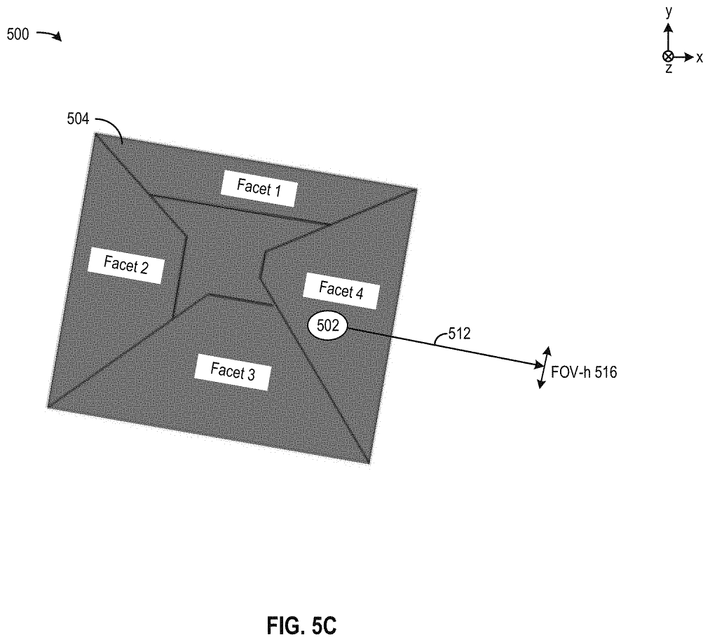

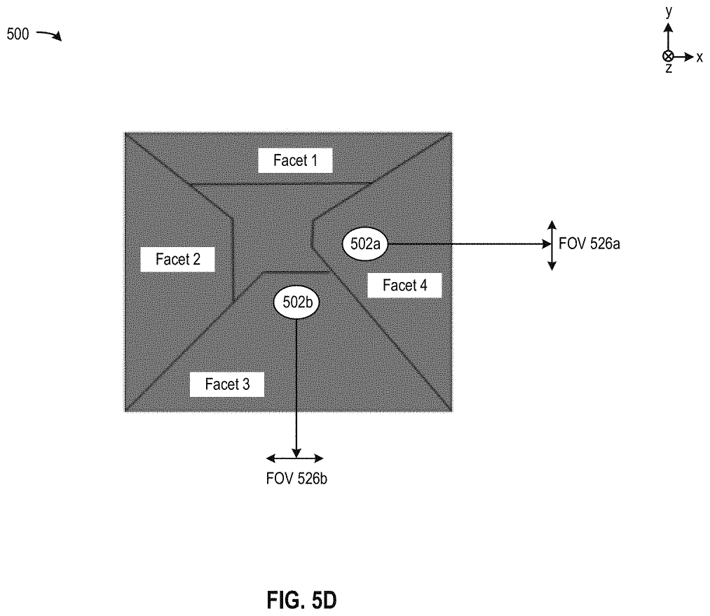

Various examples of mechanisms of adjusting the FOV of the illuminator are proposed. In one example, as shown in FIG. 5A and FIG. 5B, the LiDAR system can include a multi-facet polygon that is mounted on a supporting surface. The polygon is also rotatable by an actuator (e.g., a motor) on the supporting surface. Each facet can provide a light reflecting surface and have a different slope angle with respect to the supporting surface. The LiDAR system can further include a light source positioned over the polygon and configured to project light onto one of the light reflecting surfaces of the polygon when the polygon is rotated to position the light reflecting surface below the light source. Due to the different slope angles, each facet can reflect the light from the light source towards a different vertical FOV when positioned below the light source. To select a vertical FOV, the controller selects the facet associated with the selected vertical FOV by rotating the polygon to position the selected facet under the light source. After the polygon stops, the controller can turn on the light source to project the light onto the selected facet to illuminate the selected vertical FOV. The controller can rotate the polygon to select different facets to illuminate multiple vertical FOVs at different times. In addition, the polygon can also be controlled to set the horizontal FOV. For example, referring to FIG. 5C, the controller can rotate the polygon to set the orientation of the selected facet (and its normal axis) on the x-y plane to select a horizontal FOV. The controller can rotate the polygon to set different orientations of the selected facet at different times to illuminate multiple horizontal FOVs at different times. Further, as shown in FIG. 5D, in some examples the LiDAR system can include multiple light sources positioned over multiple light reflecting surfaces of the polygon to illuminate multiple horizontal/vertical FOVs at the same time.

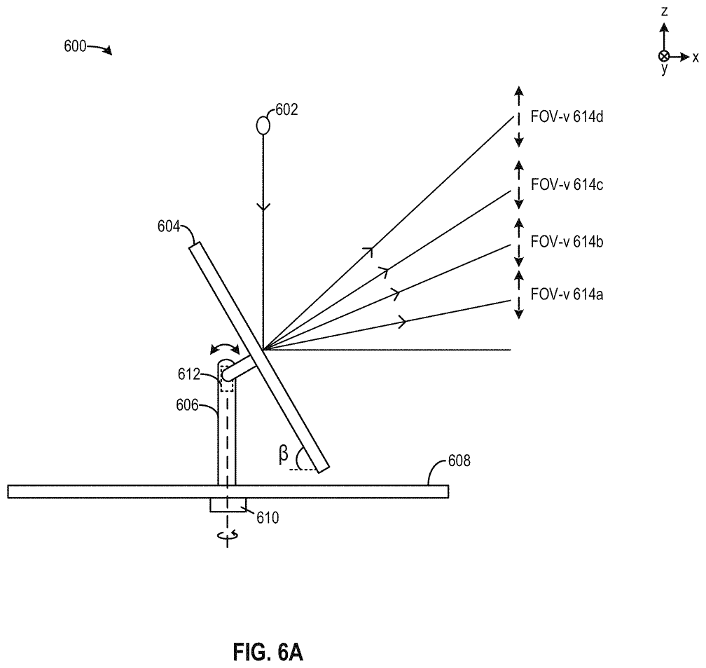

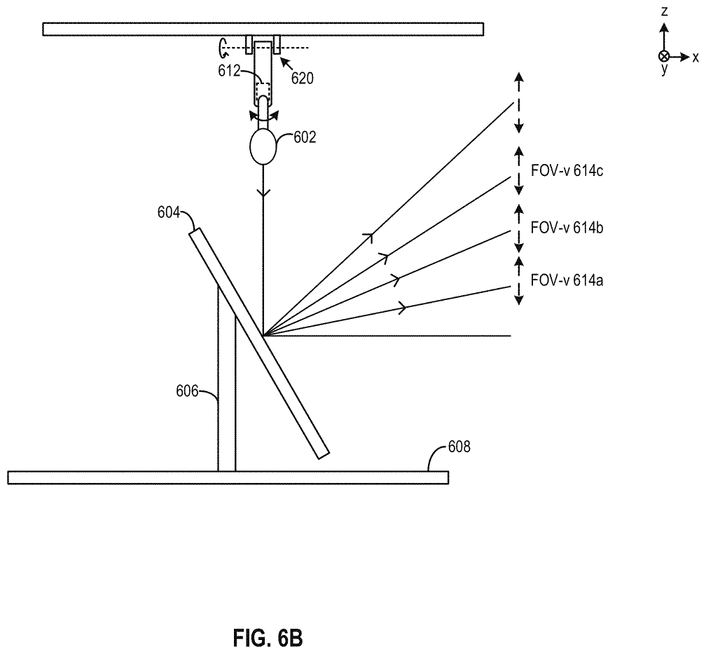

In some examples, as shown in FIG. 6A and FIG. 6B, the LiDAR system may include a single light reflecting surface mounted to a stand, and the stand can be mounted on a supporting surface. The stand (and the single light reflecting surface) is rotatable by a first actuator on the supporting surface, while the single light reflecting surface is also rotatable by a second actuator with respect to the stand to adjust a slope angle of the light reflecting surface with respect to the supporting surface. Both the first actuator and the second actuator can include motors. The LiDAR system further includes a light source positioned over the single reflecting surface. Through controlling the second actuator, the controller can control the slope angle of the single reflecting surface to illuminate a particular vertical FOV. Moreover, through controlling the first actuator, the controller can control the orientation of the normal axis of the single light reflecting surface on the x-y plane to illuminate a particular horizontal FOV. In some examples, as shown in FIG. 6B, the light source can also be connected to a first actuator and a second actuator to adjust an angle of incidence of the light onto the single light reflecting surface. The adjustment can set not only the angle of incidence but also the orientation of the plane defined by the incident path and the normal axis of the single light reflecting surface to select the vertical FOV and horizontal FOV for illumination.

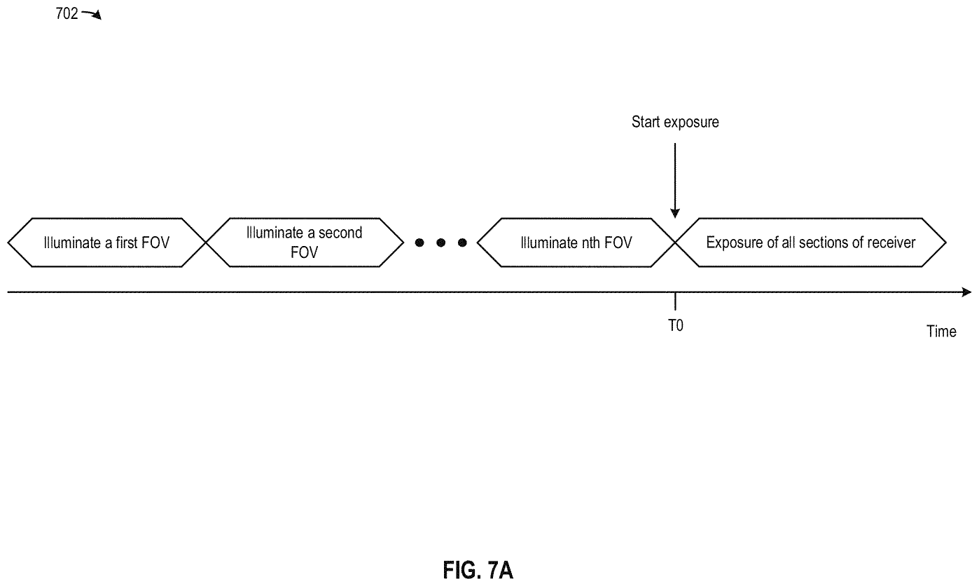

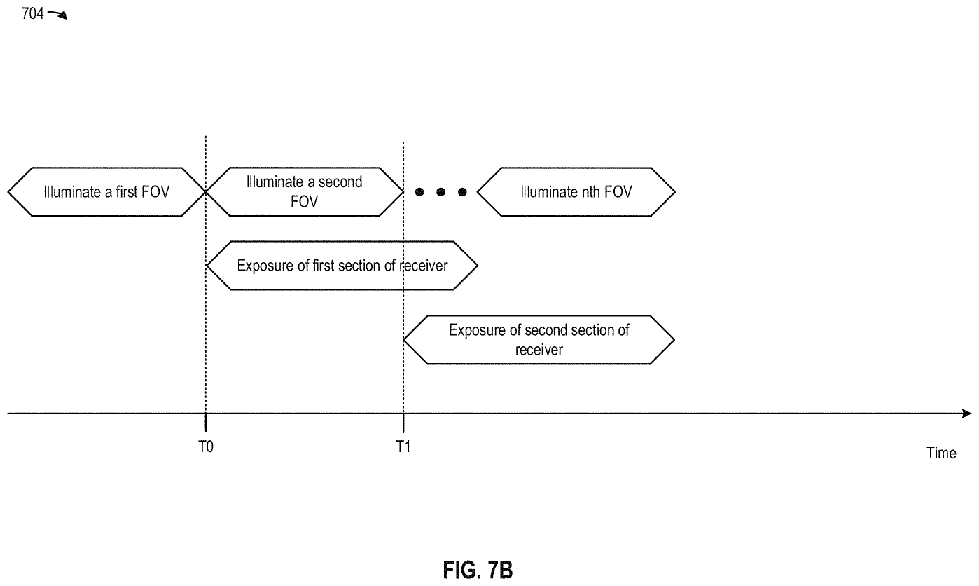

Various examples of imaging operations by the LiDAR system are also proposed. For example, as shown in FIG. 7A, the controller can start the exposure of all sections of the array of photodetectors at the same time after the illumination of all of the FOVs completes. By having all sections of the array of photodetectors start exposure time to detect reflected light at the same time, correlation in time between the pixels can improve, which can reduce motion blur in imaging fast moving objects. As another example, as shown in FIG. 7B, the receiver can start the exposure of a particular section of the array of photodetectors after illumination of the corresponding FOV completes. The arrangements of FIG. 7B can reduce the likelihood of a section of the array of photodetectors missing light reflected from close-by objects in the corresponding FOV due the delay in the start of the exposure.

With the disclosed techniques, a flash LiDAR system can illuminate multiple FOVs, and perform an object detection and ranging operation for a combined FOV comprising the multiple FOV. Such arrangements enable for imaging of a larger scene in a wider combined FOV. In addition, as the light is used to illuminate a smaller FOV of the multiple FOVs, the intensity of the light at each point within the smaller FOV can increase, which can increase the detection distance while satisfying safety requirement. Such arrangements can increase the FOV and detection distance of a flash LiDAR system to support more applications that require longer detection ranges, such as autonomous lane changing operations, or full autonomous driving operations, etc.

### Typical System Environment for Certain Examples

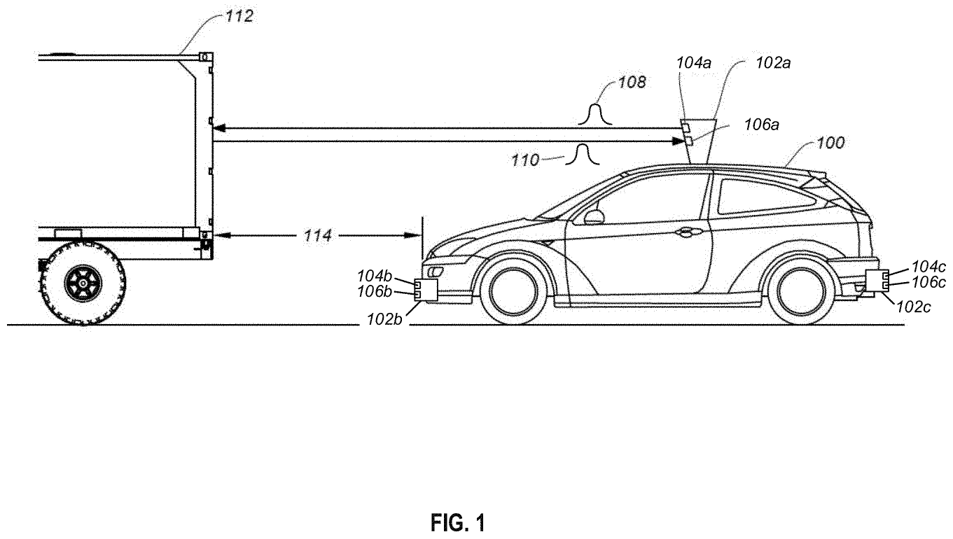

FIG. 1 illustrates an autonomous vehicle 100 in which the disclosed techniques can be implemented. Autonomous vehicle 100 includes one or more LiDAR modules 102, such as LiDAR modules 102a, 102b, and 102c. LiDAR modules 102 allows autonomous vehicle 100 to perform object detection and ranging in a surrounding environment. Based on the result of object detection and ranging, autonomous vehicle 100 can maneuver to avoid a collision with the object. In some examples, LiDAR module 102a can be positioned on the top of autonomous vehicle 100, whereas LiDAR modules 102b and 102c can be positioned at corners of autonomous vehicle 100 (e.g., at the front and back bumpers) for blind spot detection.

Each of LiDAR module 102a, 102b, and 102c includes an illuminator 104 (e.g., one of illuminators 104a, 104b, or 104c) and a receiver 106 (e.g., one of receivers 106a, 106b, or 106c). Illuminator 104 can project one or more light signals 108, whereas receiver 106 can monitor for a light signal 110, which is generated by the reflection of light signal 108 by an object. Light signal 108 can include, for example, a light pulse, a frequency modulated continuous wave (FMCW) signal, or an amplitude modulated continuous wave (AMCW) signal. LiDAR modules 102a-102c can detect the object based on the reception of light signal 110 and can perform a ranging determination (e.g., a distance of the object) based on a time difference between light signals 108 and 110. For example, as shown in FIG. 1A, LiDAR module 102 can transmit light signal 108 at a direction directly in front of autonomous vehicle 100 at time T1 and receive light signal 110 reflected by an object 112 (e.g., another vehicle) at time T2. Based on the reception of light signal 110, LiDAR module 102 can determine that object 112 is directly in front of autonomous vehicle 100. Moreover, based on the time difference between T1 and T2, LiDAR module 102 can also determine a distance 114 between autonomous vehicle 100 and object 112. Autonomous vehicle 100 can adjust its speed (e.g., slowing or stopping) to avoid collision with object 112 based on the detection and ranging of object 112 by LiDAR module 102.

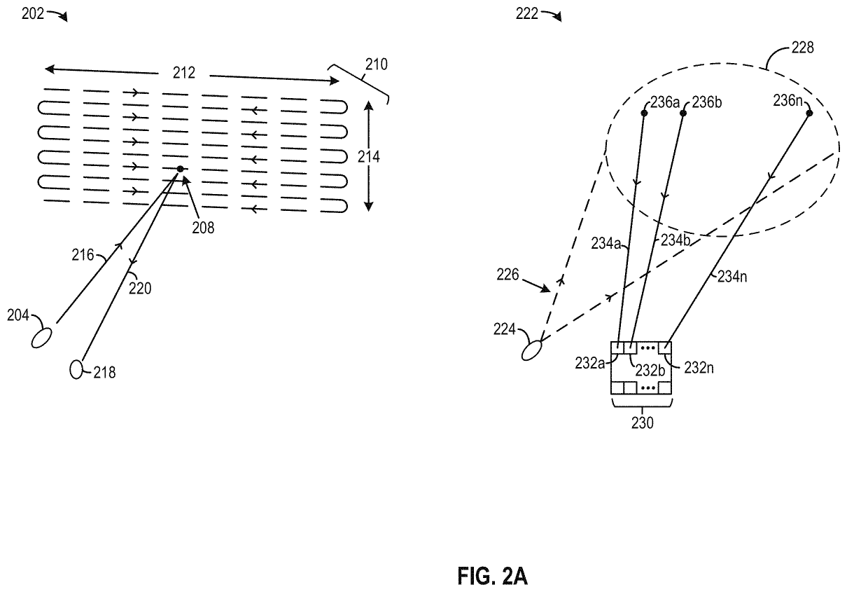

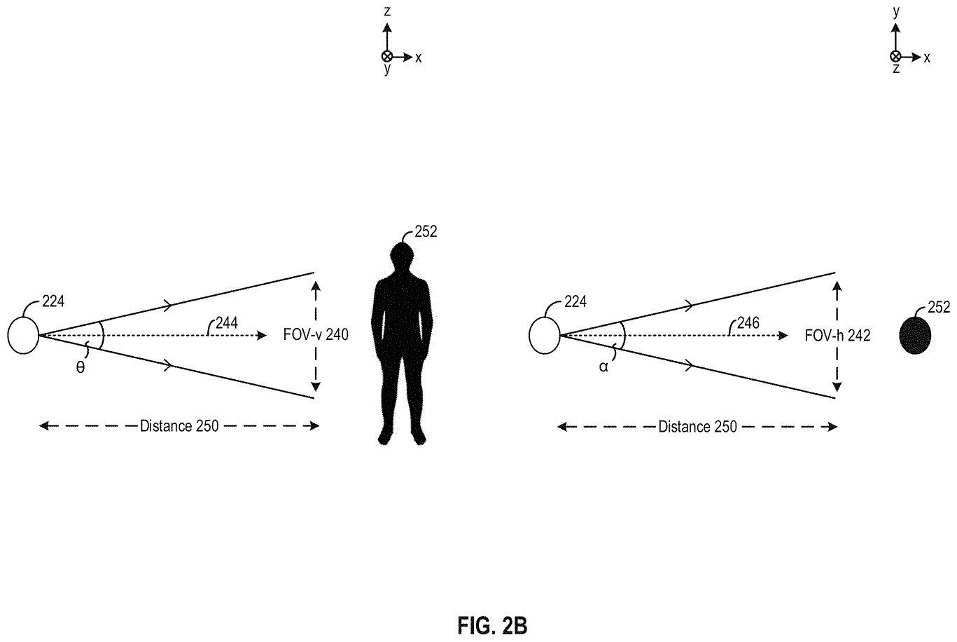

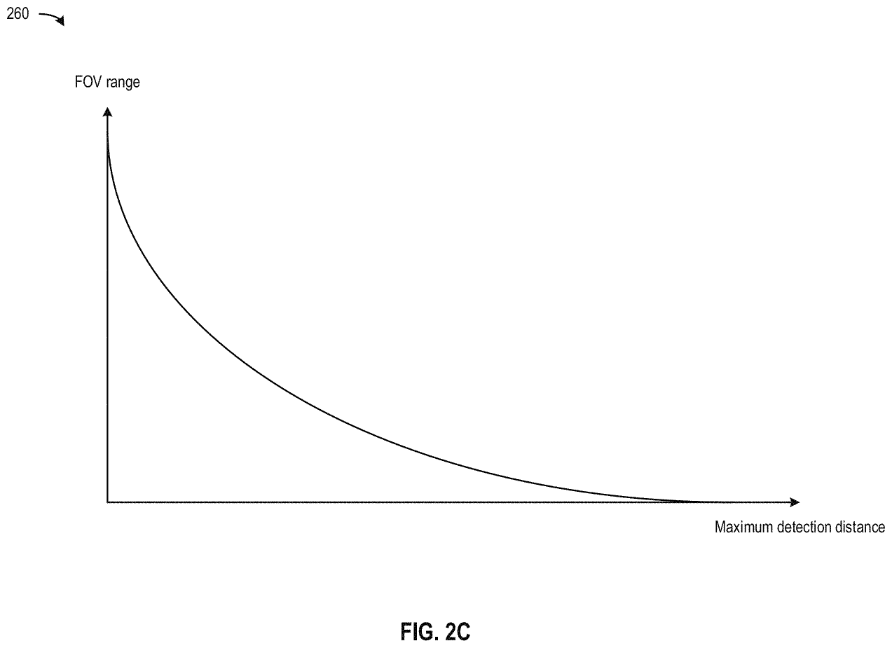

LiDAR modules 102 can include various types of LiDAR systems, such as a scanning LiDAR system, a flash LiDAR system, etc. FIG. 2A illustrates examples of operations of a scanning LiDAR system and a flash LiDAR system. The left side of FIG. 2A illustrates a detection operation 202 of a scanning LiDAR system. As part of detection operation 202, a light source 204 can be controlled to project a collimated light beam 206 to illuminate a single point, such as point 208, within a FOV 210 at a time. Collimated light beam 206 can include light signal 108 of FIG. 1. The scanning LiDAR system can include other components (not shown in FIG. 2A) to change the projection direction of collimated light beam 206 to illuminate different points within FOV 210. In some examples, the projection direction can be changed following a raster scanning pattern to sweep through a horizontal range 212 and a vertical range 214 to illuminate the entirety of FOV 210 point-by-point. A point sensor 218 can detect/monitor for a-reflected beam from each illuminated point, such as reflected beam 220, within FOV 210, and a time difference between the transmitted light and the reflected light (if any) from the point can be used to determine the depth of the point from point sensor 218.

The right side of FIG. 2A illustrates a detection operation 222 of a flash LiDAR system. As part of detection operation 222, a light source 224 can project a wide diverging beam 226 to illuminate the entirety of a FOV 228. Diverging beam 226 can include a single light pulse (e.g., a single laser pulse). A receiver 230, which can include a 1-D or 2-D array of photodetectors such as photodetectors 232a, 232b, 232n, etc., can then detect reflected beams such as reflected beams 234a, 234b, 234n from, respectively, points 236a, 236b, and 236n within FOV 228. Each reflected beam can include a reflected light pulse. Each photodetector can include one or more pixel cells to generate a detection output including one or more pixels. The pixels can be used to measure a time difference between the single pulse and the reflected light pulse from a point in the field of view, and a 1-D or 2-D distribution of depths can be obtained.

A flash LiDAR system can offer several advantages over a scanning LIDAR system. Specifically, as shown in operation 222, by illuminating the entire FOV with a single laser pulse, the entire scene within a FOV can be imaged with a single laser flash. Such arrangements allow generation of an image in which each pixel is captured at the same time, which can avoid motion blurring in the image due to motion of the target subject. Additionally, as each image can generated from a single illumination, rather than from a scanning pattern of illumination (such as operation 202) which takes a much longer time to complete, images of the target object can be produced at a higher frame rate. All these enable the flash LiDAR system to capture images of fast moving objects to support detection and ranging operations. This makes flash LiDAR ideal for applications that require fast response time, such as blind spot detections for a vehicle.

The performance of a LiDAR system can be evaluated based on various metrics, such as the sizes of FOV and detection distance. FIG. 2B illustrates examples of FOVs and detection distance. Referring to FIG. 2B (and FIG. 2A), the FOV can be two-dimensional and defined by a vertical FOV 240 (along the z-axis) and a horizontal FOV 242 (along the x/y axes). In a case of a flash LiDAR, the vertical and horizontal FOVs can be defined by a beam divergence angle of the illumination light beam (e.g., light beam 226 from light source 224) as well as the direction of propagation of the illumination light beam. For example, vertical FOV 240 is defined by an angle θ that centers on propagation direction 244, whereas horizontal FOV 242 is defined by an angle α that centers around propagation direction 246. On the other hand, in a case of a scanning LiDAR, the vertical and horizontal FOV ranges can be defined by the horizontal and vertical ranges (e.g., horizontal range 212 and vertical range 214) of the scanning operations. The FOV can define the extent of a scene to be detected and/or illuminated by the LiDAR system. A wider FOV means a larger extent of a scene can be imaged, which can lead to more objects in the scene to be detected.

In addition, a detection distance 250 of the LiDAR system can refer to the maximum distance at which a reflected signal from an object, such as object 252, can be detected by the LiDAR system. The LiDAR system has a maximum detection distance due to the attenuation of transmitted signal en route to the object, as well as the attenuation of the reflected signal from the object back to the receiver. Moreover, the receiver has finite sensitivity and cannot distinguish the received signal from noise if the received signal level is below the noise floor of the receiver. The detection distance can be defined by the intensity of light signal transmitted by the light source, as well as the sensitivity of the receiver. A longer detection distance means more distant objects can be detected and for which ranging operations can be performed.

Both a wider FOV and a longer detection distance are desirable, as they allow the LiDAR system to detect more objects in the surrounding and to provide more information about the environment the LiDAR system operates in. This is especially critical in a case where the LiDAR system supports the operation of a vehicle, since the traffic conditions around the vehicle can be complex and fast changing. A driver, or an autonomous driving system, needs as much information about the surrounding as possible to maneuver the vehicle and to detect and avoid potential dangers created by other vehicles and/or pedestrians.

But FOV and detection distance can require a trade-off, especially in a case of flash LiDAR. FIG. 2C illustrates an example graph 260 of a relationship between the FOV range and maximum detection distance. As described above, the maximum detection distance can be defined by the intensity of light projected by the LiDAR system due to the attenuation of the light as it travels over a distance. In the case of flash LiDAR, as the flash LiDAR illuminates the FOV with a divergent light beam, the energy of the light beam is distributed within the FOV. A larger FOV may require a higher beam divergence, which in turn reduces the intensity of light at each point within the FOV, as well as the detection distance. Therefore, a large FOV may lead to a short maximum detection distance, and vice versa. In graph 250, the FOV range can be related to the maximum distance based on the following Equation:

$$FOV range ∝ \frac{K}{{( max detection distance )}^{2}} \qquad ( Equation 1 )$$

In addition, the intensity of light may be further reduced to avoid projecting high power layer to pedestrians/drivers at vicinity to improve safety. All these can further limit the application of flash LiDAR. For example, due to the short detection range, flash LiDAR is typically used in blind spot detection during a parking operation which does not require long detection range. But other applications that require longer detection ranges, such as autonomous lane changing operations, or even full autonomous driving operations, may not be able to use flash LiDAR and cannot leverage the high performance of flash LiDAR in detecting fast moving objects.

### Example Techniques to Provide Extended FOV for a LiDAR System

Examples of the present disclosure relate to a LiDAR system, such as a flash LiDAR, that can address at least some of the problems described above. FIG. 3A-FIG. 3C illustrate an example LiDAR system 300 and its operations. As shown in FIG. 3A, LiDAR system 300 can include an illuminator 302 having an adjustable field of view (FOV), a receiver 304, and a controller 306 to control the operations of illuminator 302 and receiver 304. Illuminator 302 can include one or more light sources and can be controlled to illuminate a FOV. Controller 306 can control illuminator 302 to illuminate multiple FOVs, with each FOV being illuminated by light of a different propagation path from illuminator 302. In a case where illuminator 302 includes a single light source, illuminator 302 can be controlled to illuminate each of multiple FOVs at different times. In a case where illuminator 302 includes multiple light sources, each light source can illuminate a different FOV, and multiple FOVs can be illuminated at the same time. Receiver 304 can detect light reflected from each of the illuminated FOVs to generate a detection output for a combined FOV including the multiple FOVs.

In some examples, LiDAR system 300 can be part of a flash LiDAR system in which illuminator 302 is configured to illuminate a FOV with a divergent beam that carries a single pulse, and receiver 304 includes an array (e.g., a 1-D array, a 2-D array) of photodetectors to detect light reflected from the illuminated FOV. Compared with a conventional flash LiDAR system that has a fixed FOV, LiDAR system 300 can provide an expanded FOV by combining multiple FOVs to detect a larger part of a scene. Moreover, each of the multiple FOVs can be made small with a narrow range, which allows the light output by illuminator 302 to become more concentrated within the FOV. This can increase the intensity of the light projected to each point within the smaller FOV, which in turn can increase the detection distance. Meanwhile, as the light output by the light source is used to only illuminate a small FOV, the intensity of the light output by the light source can be reduced to satisfy the safety requirement. Such arrangements can provide a flash LiDAR system having a wide FOV and a long maximum detection distance to support more applications, such as autonomous lane changing operations, full autonomous driving operations, etc.

FIG. 3B illustrates examples of illuminations of multiple FOVs by illuminator 302. As shown on the left of FIG. 3B, illuminator 302 can be controlled to illuminate multiple vertical FOVs, including vertical FOVs 308a, 308b, and 308c each spanning, respectively, different ranges along the vertical axis (e.g., the z-axis), and the same range on the horizontal plane (e.g., the x-y plane). Each vertical FOV can be defined by a beam divergence angle centered on a propagation direction of the divergent light beam that illuminates the vertical FOV. For example, vertical FOV 308a can be defined by an angle θ1 centered on a light propagation direction 310a, vertical FOV 308b can be defined by an angle θ2 centered on a light propagation direction 310b, whereas vertical FOV 308c can be defined by an angle θ3 centered on a light propagation direction 310c. As to be described below, illuminator 302 can be controlled to illuminate each FOV multiple vertical FOVs 308a, 308b, and 308c at different times. In some examples, illuminator 302 can also be controlled to illuminate two or more FOVs of multiple vertical FOVs 308a, 308b, and 308c at the same time. Receiver 304 can receive light reflected from each of vertical FOVs 308a, 308b, and 308c and generate a detection output for a combined vertical FOV comprising vertical FOVs 308a, 308b, and 308c.

In addition, as shown on the right of FIG. 3B, illuminator 302 can also be controlled to illuminate multiple horizontal FOVs, including vertical FOVs 318a, 318b, and 318c each spanning, respectively different ranges on the horizontal plane (e.g., the x-y-plane) and the same range on the vertical axis (e.g., the z-axis). Each horizontal FOV can be defined by a beam divergence angle centered on a propagation direction of the divergent light beam that illuminates the horizontal FOV. For example, horizontal FOV 318a can be defined by an angle α1 centered on a light propagation direction 320a, vertical FOV 318b can be defined by an angle α2 centered on a light propagation direction 320b, whereas vertical FOV 318c can be defined by an angle α3 centered on a light propagation direction 320c. As to be described below, illuminator 302 can be controlled to illuminate each FOV of multiple horizontal FOVs 318a, 318b, and 318c at different times. Illuminator 302 can also illuminate two or more FOVs of multiple horizontal FOVs 318a, 318b, and 318c at the same time. Receiver 304 can receive light reflected from each of horizontal FOVs 318a, 318b, and 318c and generate a detection output for a combined horizontal FOV comprising horizontal FOVs 318a, 318b, and 318c.

In the examples shown in FIG. 3B, three horizontal and vertical FOVs are shown, but it is understood that illuminator 302 can illuminate more than three FOVs (e.g., four FOVs, five FOVs). Moreover, there can also be overlaps between the FOVs. In addition, although not shown in FIG. 3B, it is understood that illuminator 302 can also be configured to illuminate different FOVs each having a different horizontal range and a different vertical range.

FIG. 3C illustrates examples of arrangements of receiver 304. Receiver 304 can include an array of photodetectors 232 to detect light reflected from the multiple FOVs. In some examples, the array of photodetectors can be divided into sections, with each section assigned to detect light reflected from a particular FOV. For example, on the left of FIG. 3C, the array of photodetectors 232 can be divided into a 1-D array of row sections 332a, 332b, 332n, etc. Each row section 332 includes one or more rows of photodetectors 232 and can be assigned to receive light reflected from a particular vertical FOV (e.g., one of vertical FOVs 308a, 308b, and 308c of FIG. 3B). Moreover, in the middle of FIG. 3C, the array of photodetectors 232 can be divided into a 1-D array of column sections 342a, 342b, 342n, etc. Each column section 342 includes one or more columns of photodetectors 232 and can be assigned to receive light reflected from a particular horizontal FOV (e.g., one of horizontal FOVs 318a, 318b, and 318c of FIG. 3B). Further, on the right of FIG. 3C, the array of photodetectors 232 can be divided into a 2-D array of sections 352a0, 352b0, 352n0, 352a1, 352b1, 352n1, 352am, 352bm, 352nm, etc., with each section 352 including a 2-D array of photodiodes 232. Each section 352 can be assigned to receive light reflected from a FOV having a particular vertical and horizontal ranges, in a case where illuminator 302 is configured to illuminate different FOVs each having a different horizontal range and a different vertical range.

FIG. 4 illustrates an example arrangement of an illuminator 400 to provide an adjustable FOV. Referring to FIG. 4, illuminator 400 can include a light source 402 (e.g., a laser source) and a light reflecting surface 404 to reflect incident light 406 projected by light source 402. Light reflecting surface 404 can reflect incident light 406 at a particular angle of reflection to project the reflected light 408, and the angle of reflection can set the FOV of the illumination. The angle of reflection can be determined based on an orientation of a normal axis 410 of light reflecting surface 404 with respect to the incident path of the light. Light reflecting surface 404 can be a flat planar surface, or a curved surface.

The left of FIG. 4 illustrates a case where incident light 406 travels along a direction that is perpendicular to the x-y plane (e.g., parallel with the z-axis) before incident upon light reflecting surface 404. Normal axis 410 and the propagation path of incident light 406 can form a plane 412 that is also perpendicular to the x-y plane. The angle of incidence i between normal axis 410 and the propagation path of incident light 406 can determine the angle of reflection r, and the angle of reflection r can determine a vertical FOV 420 illuminated by reflected light 408 on the z-axis. Moreover, the orientation of plane 412 (and normal axis 410) on the x-y plane can also define a horizontal FOV 430 on the x-y plane. For example, on the left of FIG. 4, assuming that normal axis 410 and plane 412 are parallel with the y-z plane, the horizontal FOV illuminated by reflected light 408 can be aligned with illuminator 402 along the y-axis. On the other hand, if light reflecting surface 404 is rotated around the z-axis by 90 degrees such that normal axis 410 and plane 412 become parallel with the x-axis, the horizontal FOV illuminated by reflected light 408 can be aligned with illuminator 402 along the x-axis.

The FOV illuminated by reflected light 408 can be adjusted based on various mechanisms. For example, referring to the left of FIG. 4, to change the vertical FOV illuminated by reflected light 408, the slope angle β between light reflecting surface 404 and the x-y plane can be adjusted to change the angle of incidence i, which in turn can change the angle of reflection r. In addition, light reflecting surface 404 can also be rotated around the z-axis to change the orientation of plane 412, to change the horizontal FOV illuminated by reflected light 408. In some examples, as shown on the right of FIG. 4, instead of projecting light 406 along the z-axis onto light reflecting surface 404, light source 402 can be configured to project light 406 at a different direction towards light reflecting surface 404, which can change both the angle of incidence i (and angle of reflection r) as well as the orientation of plane 412. By changing the propagation direction of light 406 with respect to light reflecting surface 404 (and normal axis 410), both the vertical FOV and horizontal FOV can be adjusted.

Although FIG. 4 illustrates a flat and planar light reflecting surface, it is understood that a curved light reflecting surface can also be used to adjust the vertical/horizontal FOV. For example, the orientation of the normal axis at the incident point of light on the curved surface can determine the vertical and horizontal FOV being illuminated by the reflected light.

FIG. 5A to FIG. 5D illustrate an example of illuminator 500 having adjustable FOV. Illuminator 500 can be part of illuminator 302 of FIG. 3A and controlled by controller 306. As shown in FIG. 5A, illuminator 500 can include a light source 502 (e.g., a laser source) and a multi-facet polygon 504. Polygon 504 can be made of a metallic material. Polygon 504 can be mounted on a supporting surface 506 which, in the example of FIG. 5A, can be parallel with the x-y plane. Polygon 504 is also rotatable by an actuator 508 (e.g., a motor) on supporting surface 506. Controller 306 can control actuator 508 to rotate polygon 504.

Each facet of polygon 504 can provide a light reflecting surface and can have a different slope angle β with respect to supporting surface 506. Light source 502 can project light 510 onto one facet at a time when polygon 504 is rotated to position the facet below light source 502. The facet can then reflect the light as light 512 to illuminate a FOV. Due to the different slope angles, each facet of polygon 504 can reflect the light from light source 502 along a different projection path towards a different vertical FOV when positioned below the light source, as explained in FIG. 4. In the example of FIG. 5A, polygon 504 may include four facets, although it is understood that polygon 504 can include any number of facets. Each facet can reflect light 512 along a particular projection path that forms a particular angle with respect to supporting surface 506. The angle can be represented by a sum of a base angle b and an adjustment angle a1, a2, a3, and a4 for each facet. By projecting the reflected light at different angles with respect to supporting surface 506 (and x-y plane), different vertical FOVs can be illuminated, where the range of each vertical FOV can be defined based both the projection path angle as well as the divergence of light 512. For example, vertical FOV 514a can be defined based on angle b+a1, vertical FOV 514b can defined based on angle b+a2, vertical FOV 514c can be defined based on angle b+a3, whereas vertical FOV 514d can be defined based on angle b+a4. Vertical FOVs 514a-514d can correspond to, for examples, θ1, θ2, θ3, and θ4 of FIG. 3A.

FIG. 5B and table 1 below illustrate examples of slope angles β of facets of polygon 504, as well as the corresponding angles of propagation path of reflected light 512 with respect to supporting surface 506. Assuming that light source 502 projects light 510 along the z-axis towards polygon 504, the angles of propagation path (optical angles) can be double of the slope angles. In Table 1 below, b is the base angle, adjustment angles a1, a2, a3, and a4 are represented by different fractions of φ.

TABLE 1

| | Facet 1 | Facet 2 | Facet 3 | Facet 4 |
|---|---|---|---|---|
| Slope angle β | $\frac{b}{2} + \frac{φ}{16}$ | $\frac{b}{2} + \frac{3 φ}{16}$ | $\frac{b}{2} + \frac{5 φ}{16}$ | $\frac{b}{2} + \frac{7 φ}{16}$ |
| Optical angle | $b + \frac{φ}{8}$ | $b + \frac{3 φ}{8}$ | $b + \frac{5 φ}{8}$ | $b + \frac{7 φ}{8}$ |

To select a vertical FOV, controller 306 can select the facet associated with the selected vertical FOV by rotating polygon 504 to position the selected facet under light source 502. After the polygon stops, controller 306 can turn on light source 502 to project light 510 onto the facet to illuminate the selected vertical FOV. Controller 306 can then rotate polygon 504 to select different facets to illuminate multiple vertical FOVs at different times.

In addition, polygon 504 can be rotated to set a horizontal FOV. For example, referring to FIG. 5C, the controller can rotate the polygon to set the orientation of the normal axis of the selected light reflecting surface on the x-y plane, to select a horizontal FOV, such as horizontal FOV 516. The controller can rotate polygon 504 to set different orientations of the selected facet (e.g., facet 4) at different times, to illuminate multiple horizontal FOVs at different times.

In some examples, as shown in FIG. 5D, illuminator 500 can include multiple light sources positioned over multiple facets to illuminate multiple horizontal/vertical FOVs at the same time. Such arrangements can widen the horizontal/vertical FOVs being illuminated. Provided that the FOVs do not overlap, such arrangements can also avoid increasing the light intensity in a given FOV to satisfy safety requirement. In the example of FIG. 5D, illuminator 500 can include a light source 502a and a light source 502b each be positioned over a selected facet, and two facets can be selected to perform illumination at a time. For example, in a case where facets 3 and 4 are selected, illuminator 500 can illuminate a FOV 526a and a FOV 526b, each can be a selected vertical FOV, a selected horizontal HOV, or both, simultaneously.

Although FIG. 5A to FIG. 5D illustrate that polygon 504 includes flat planar surfaces, it is understood that polygon 504 can also include one or more curved surfaces. The curved surfaces can also join as a continuous curved surface on polygon 504. The orientation of the normal axis at the incident point of light on the curved surface can determine the vertical and horizontal FOV being illuminated by the reflected light.

FIG. 6A and FIG. 6B illustrate another example of an illuminator 600 having an adjustable FOV. Illuminator 600 can be part of illuminator 302 of FIG. 3A and controlled by controller 306. As shown in FIG. 6A, illuminator 600 may include a light source 602 and a single light reflecting surface 604. Light reflecting surface 604 can be mounted to a stand 606, and stand 606 can be mounted on a supporting surface 608. In the example of FIG. 6A, supporting surface 608 can be parallel with the x-y plane. Stand 606 (and single light reflecting surface 604) is rotatable by a first actuator 610 (e.g., a motor) around the z-axis on supporting surface 608, while single light reflecting surface 604 is also rotatable by a second actuator 612 with respect to stand 606 to adjust a slope angle β of the light reflecting surface with respect to the supporting surface. Through controlling second actuator 612, controller 306 can control the slope angle of single reflecting surface 604 to illuminate different vertical FOVs including, for example, vertical FOVs 614a, 614b, 614c, and 614d. In addition, through controlling first actuator 610, the controller can control the orientation of the normal axis of single light reflecting surface 604 on the x-y plane, to illuminate a particular horizontal FOV.

In some examples, as shown in FIG. 6B, light source 602 can also be connected to a first actuator 620 and a second actuator 622 to adjust an angle of incidence of the light onto single light reflecting surface 604. The adjustment can set not only the angle of incidence but also the orientation of the plane defined by the incident path and the normal axis of the light reflecting surface 604, to select the vertical FOV and horizontal FOV for illumination, as explained in FIG. 4. For example, second actuator 622 can tilt light source 602 on the x-z plane to illuminate different vertical FOVs, whereas first actuator 620 can tilt light source 602 on the y-z plane to adjust the horizontal FOV and vertical FOV to be illuminated.

Referring back to FIG. 3A, controller 306 can control illuminator 302 and receiver 304 to perform an imaging operation to obtain information of a scene. FIG. 7A illustrates an example imaging operation 702. As shown in FIG. 7A, controller 306 can start the exposure of all sections of the array of photodetectors at the same time (e.g., at time TO), after the illumination of all of the FOVs completes. By having all sections of the array of photodetectors to start the exposure time to detect reflected light at the same time, correlation in time between the pixels can improve, which can reduce motion blur in imaging fast moving objects. FIG. 7B illustrates another example imaging operation 704. As shown in FIG. 7B, controller 306 can start the exposure of a particular section of the array of photodetectors after illumination of the corresponding FOV completes. For example, after the illumination of a first FOV completes at time TO, controller 306 can start the exposure of a first section of array of photodetectors of receiver 304 at time TO. Moreover, after the illumination of a second FOV completes at time T1, controller 306 can start the exposure of a second section of array of photodetectors of receiver 304 at time T1. The arrangements of FIG. 7B can reduce the likelihood of a section of the array of photodetectors missing light reflected from close-by objects in the corresponding FOV due to the delay in the start of the exposure.

### Method of Operating a LiDAR System Having Adjustable FOV

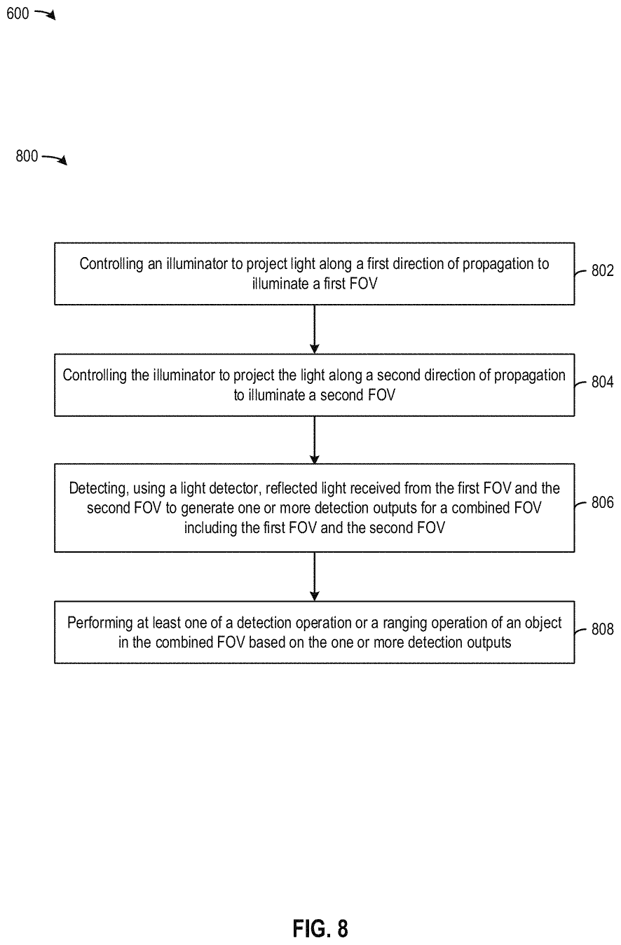

FIG. 8 illustrates a method 800 of operating a LiDAR System, such as LiDAR system 300 of FIG. 3A, that has an illuminator having an adjustable field of view (FOV), a receiver, and a controller. Method 800 can be performed by the controller. The illuminator can be controlled by the controller to illuminate multiple FOVs. Each FOV can span different ranges along a vertical axis and/or along a horizontal axis, and can be illuminated by light of a different propagation direction from the illuminator. In some examples, the illuminator and the receiver can be part of a flash LiDAR system. The illuminator can include one or more light sources controlled by the controller to illuminate each of the multiple FOVs with a divergent light beam, such as a divergent laser beam, that carries a single light pulse. Each FOV can be illuminated by a divergent light beam having a particular propagation direction from the illuminator.

Referring to FIG. 4, the illuminator can include a light reflecting surface to reflect the incident light projected by a light source of the illuminator. The light reflecting surface can reflect the incident light at a particular angle of reflection, and the angle of reflection can set the FOV of the illumination. The angle of reflection can be determined based on a relative orientation of the normal axis of the light reflecting surface with respect to the incident path of the light. The relative orientation can be set based on, for example, a slope angle of the light reflecting surface, the orientation of the light reflecting surface, and/or a direction of projection of the incident light by the light source to the light reflecting surface. In some examples, referring to FIG. 5A and FIG. 5B, the LiDAR system can include a multi-facet polygon that is mounted on a supporting surface. The polygon is also rotatable by an actuator (e.g., a motor) on the supporting surface. Each facet can provide a light reflecting surface and have a different slope angle with respect to the supporting surface.

In some examples, as shown in FIG. 6A and FIG. 6B, the LiDAR system may include a single light reflecting surface mounted to a stand, and the stand can be mounted on a supporting surface. The stand (and the single light reflecting surface) is rotatable by a first actuator on the supporting surface, while the single light reflecting surface is also rotatable by a second actuator with respect to the stand to adjust a slope angle of the light reflecting surface with respect to the supporting surface. In some examples, as shown in FIG. 6B, the light source can also be connected to a first actuator and a second actuator to adjust an angle of incidence of the light onto the single light reflecting surface.

In step 802, the controller can control the illuminator to project light along a first direction of propagation to illuminate a first FOV of the multiple FOVs. The controller can control the illuminator to illuminate the first FOV by, for example, rotating the multi-facet polygon to choose a first facet having a first slope angle to illuminate the first FOV. The controller can also adjust a slope angle of a single surface mounted to a stand, and/or adjust the orientation of a light source to set a first incident angle of the light onto the single surface, to illuminate the first FOV.

In step 804, the controller can control the illuminator to project light along a second direction of propagation to illuminate a second FOV of the multiple FOVs. The controller can control the illuminator to illuminate the second FOV by, for example, rotating the multi-facet polygon to choose a second facet having a second slope angle to illuminate the second FOV. The controller can also adjust a slope angle of the single surface mounted to a stand, and/or adjust the orientation of a light source to set a second incident angle of the light onto the single surface, to illuminate the second FOV.

In step 806, a light detector of the receiver can detect reflected light received from the first FOV and the second FOV to generate one or more detection outputs for a combined FOV including the first FOV and the second FOV. For example, the receiver can include an array (1-D or 2-D) of photodetectors to detect light reflected from each illuminated FOV. As shown in FIG. 3C, the array of image sensors can be divided into sections, with each section corresponding to a particular FOV to be imaged by the illuminator. In some examples, the controller can start the exposure of all sections of the array of photodetectors at the same time after the illumination of all of the FOVs completes, to improve correlation in time between the pixels can improve, which can reduce motion blur in imaging fast moving objects. In some examples, the receiver can start the exposure of a particular section of the array of photodetectors after illumination of the corresponding FOV completes, which can reduce the likelihood of a section of the array of photodetectors missing light reflected from close-by objects in the corresponding FOV due the delay in the start of the exposure.

In step 808, the controller can perform at least one of a detection operation or a ranging operation of an object in the combined FOV based on the one or more detection outputs.

### Computing System

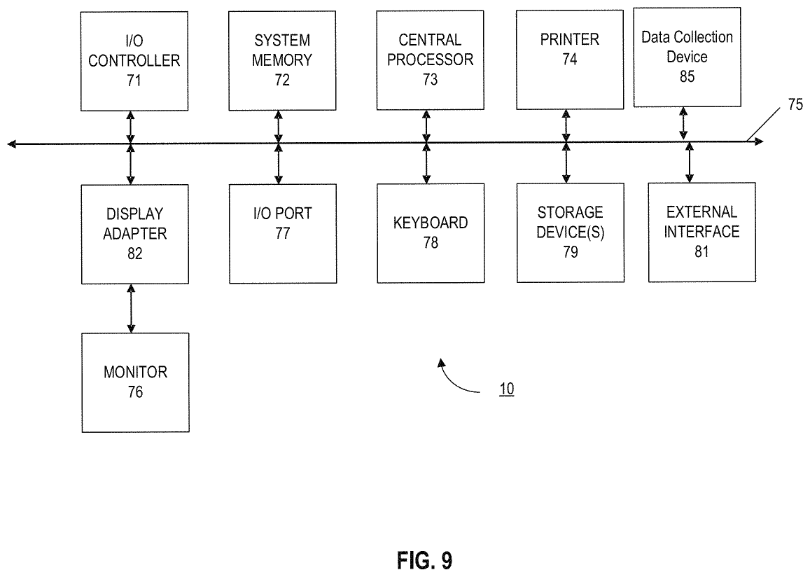

Any of the computing systems mentioned herein may utilize any suitable number of subsystems. Examples of such subsystems are shown in FIG. 9, in computing system 10. In some examples, a computing system includes a single computing apparatus, where the subsystems can be the components of the computing apparatus. In other examples, a computing system can include multiple computing apparatuses, each being a subsystem, with internal components. Computing system 10 can include, for example, a field-programmable gate array (FPGA), an application-specific integrated circuit (ASIC), and a general-purpose central processing unit (CPU), to implement the disclosed techniques, including the techniques described from FIG. 2A-FIG. 8, such as controller 306. In some examples, computing system 10 can also include desktop and laptop computers, tablets, mobile phones, and other mobile devices.

The subsystems shown in FIG. 9 are interconnected via a system bus 75. Additional subsystems such as a printer 74, keyboard 78, storage device(s) 79, monitor 76 which is coupled to display adapter 82, and others are shown. Peripherals and input/output (I/O) devices, which couple to I/O controller 71, can be connected to the computing system by any number of means known in the art, such as I/O port 77 (e.g., USB, FireWire©). For example, I/O port 77 or external interface 81 (e.g., Ethernet or Wi-Fi) can be used to connect computing system 10 to a wide-area network such as the Internet, a mouse input device, or a scanner. The interconnection via system bus 75 allows the central processor 73, which can be an FPGA, an ASIC, a CPU, etc., to communicate with each subsystem and to control the execution of a plurality of instructions from system memory 72 or the storage device(s) 79 (e.g., a fixed disk, such as a hard drive or optical disk), as well as the exchange of information between subsystems. The system memory 72 and/or the storage device(s) 79 may embody a computer-readable medium. Another subsystem is a data collection device 85, such as a camera, microphone, accelerometer, and the like. Any of the data mentioned herein can be output from one component to another component and can be output to the user.

A computing system can include a plurality of the same components or subsystems, e.g., connected together by external interface 81 or by an internal interface. In some examples, computing systems, subsystems, or apparatuses can communicate over a network. In such instances, one computer can be considered a client and another computer a server, where each can be part of a same computing system. A client and a server can each include multiple systems, subsystems, or components.

Aspects of examples can be implemented in the form of control-logic-using hardware (e.g., an ASIC or FPGA) and/or using computer software with a generally programmable processor in a modular or integrated manner. As used herein, a processor includes a single-core processor, a multi-core processor on a same integrated chip, or multiple processing units on a single circuit board or networked. Based on the disclosure and teachings provided herein, a person of ordinary skill in the art will know and appreciate other ways and/or methods to implement examples of the present disclosure using hardware and a combination of hardware and software.

Any of the software components or functions described in this application may be implemented as software code to be executed by a processor using any suitable computer language, such as, for example, Java, C, C++, C#, Objective-C, Swift, or scripting language such as Perl or Python using, for example, conventional or object-oriented techniques. The software code may be stored as a series of instructions or commands on a computer-readable medium for storage and/or transmission. A suitable non-transitory computer-readable medium can include random access memory (RAM), a read-only memory (ROM), a magnetic medium such as a hard-drive or a floppy disk, or an optical medium such as a compact disk (CD) or digital versatile disk (DVD), flash memory, and the like. The computer-readable medium may be any combination of such storage or transmission devices.

Such programs may also be encoded and transmitted using carrier signals adapted for transmission via wired, optical, and/or wireless networks conforming to a variety of protocols, including the Internet. As such, a computer-readable medium may be created using a data signal encoded with such programs. Computer-readable media encoded with the program code may be packaged with a compatible device or provided separately from other devices (e.g., via Internet download). Any such computer-readable medium may reside on or within a single computer product (e.g. a hard drive, a CD, or an entire computing system), and may be present on or within different computer products within a system or network. A computing system may include a monitor, printer, or other suitable display for providing any of the results mentioned herein to a user.

Any of the methods described herein may be totally or partially performed with a computer system including one or more processors, which can be configured to perform the steps. Thus, examples can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, units, circuits, or other means for performing these steps.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims. For instance, any of the embodiments, alternative embodiments, etc., and the concepts thereof may be applied to any other embodiments described and/or within the spirit and scope of the disclosure.

The use of the terms “a,” “an,” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning including, but not limited to) unless otherwise noted. The term “connected” is to be construed as partly or wholly contained within, attached to, or joined together, even if there is something intervening. The phrase “based on” should be understood to be open-ended and not limiting in any way and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

What is claimed is:

1. An apparatus, the apparatus being part of a Light Detection and Ranging (LiDAR) module of a vehicle and comprising:
an illuminator having an adjustable field of view (FOV), the FOV being adjusted based on setting a direction of propagation of light to illuminate the FOV;
a light detector; and
a controller configured to:
control the illuminator to project the light along a first direction of propagation to illuminate a first FOV;
control the illuminator to project the light along a second direction of propagation to illuminate a second FOV;
detect, using the light detector, reflected light received from the first FOV and the second FOV to generate one or more detection outputs for a combined FOV including the first FOV and the second FOV; and
perform at least one of a detection operation or a ranging operation of an object in the combined FOV based on the one or more detection outputs.

2. The apparatus of claim 1, wherein the illuminator is configured to:
illuminate the first FOV with a first divergent light beam that carries a first single pulse; and
illuminate the second FOV with a second divergent light beam that carries a second single pulse.

3. The apparatus of claim 1, wherein the detector comprises an array of sensors.

4. The apparatus of claim 1, wherein the first FOV and the second FOV spans different ranges along at least one of a vertical axis or a horizontal axis.

5. The apparatus of claim 1, wherein the illuminator comprises one or more light sources and one or more light reflecting surfaces;
the one or more light sources are configured to project the light to the one or more light reflecting surfaces; and
the one or more light reflecting surfaces are configured to reflect the light at a first angle of reflection and a second angle of reflection with respect to one or more normal axes of the one or more light reflecting surfaces to illuminate, respectively, the first FOV and the second FOV.

6. The apparatus of claim 5, wherein the one or more light reflecting surfaces comprises a first light reflecting surface having a first normal axis and a second light reflecting surface having a second normal axis.

7. The apparatus of claim 6, wherein the first light reflecting surface and the second light reflecting surface form a continuous curved light reflecting surface.

8. The apparatus of claim 6, wherein the one or more light sources comprise a single light source;
wherein the controller is configured to:
within a first time, cause the single light source to project the light onto the first light reflecting surface to illuminate the first FOV; and
within a second time, cause the single light source to project the light onto the second light reflecting surface to illuminate the second FOV.

9. The apparatus of claim 8, wherein the first light reflecting surface and the second light reflecting surface are, respectively, a first surface and a second surface of a polygon;
wherein the apparatus further comprises an actuator configured to rotate the polygon;
wherein the controller is configured to:
at the first time, rotate, using the actuator, the polygon by a first rotation angle such that the first light reflecting surface faces the single light source; and
at the second time, rotate, using the actuator, the polygon by a second rotation angle such that second light reflecting surface faces the single light source.

10. The apparatus of claim 9,
wherein both the first surface and the second surface are flat surfaces;
wherein the polygon is rotatably mounted on a third surface;
wherein when the polygon is rotated by the first rotation angle, the first surface forms a first slope angle with a first axis of the third surface; and
wherein when the polygon is rotated by the second rotation angle, the second surface forms a single slope angle with the first axis of the third surface.

11. The apparatus of claim 10, wherein at least one of the first surface or the second surface comprises a curved surface, such that the first FOV and the second FOV have different ranges along a horizontal axis parallel with the third surface.

12. The apparatus of claim 6, wherein the one or more light sources comprise a first light source facing the first light reflecting surface and a second light source facing the second light reflecting surface.

13. The apparatus of claim 12, wherein the controller is configured to enable the first light source and the second light source to illuminate, respectively, the first FOV via the first light reflecting surface and the second FOV via the second light reflecting surface simultaneously.

14. The apparatus of claim 1, wherein the one or more light sources comprise a single light source;
wherein the one or more light reflecting surface comprise a single mirror; and
wherein the apparatus comprises an actuator configured to set an orientation of the single mirror; and
wherein the controller is configured to:
set a first orientation of the single mirror using the actuator;
cause the single light source to project light to the single mirror at the first orientation to illuminate the first FOV;
set a second orientation of the single mirror using the actuator; and
cause the single light source to project light to the single mirror at the second orientation to illuminate the second FOV.

15. The apparatus of claim 1, wherein the illuminator comprises a light source connected to one or more actuators, and a light reflecting surface;
wherein the controller is configured to:
control the one or more actuators to tilt the light source at a first angle to project the light to the light reflecting surface at a first direction to illuminate the first FOV; and
control the one or more actuators to tilt the light source at a second angle to project the light to the light-reflecting surface at a second direction to illuminate the second FOV.

16. The apparatus of claim 1, wherein the controller is configured to:
within a first time:
control the illuminator to illuminate the first FOV; and
detect, using the light detector, reflected light received from the first FOV to generate a first detection output of the one or more detection outputs;
within a second time:
control the illuminator to illuminate the second FOV; and
detect, using the light detector, reflected light received from the second FOV to generate a second detection output of the one or more detection outputs; and
generate a combined detection output for the combined FOV based on combining the first detection output and the second detection output.

17. The apparatus of claim 1, wherein the controller is configured to:
within a first time, control the illuminator to illuminate the first FOV;
within a second time, control the illuminator to illuminate the second FOV; and
after the first time and the second time, detect, using the light detector, reflected light received from the first FOV and the second FOV to generate a combined detection output for the combined FOV.

18. A method, comprising:
controlling an illuminator to project light along a first direction of propagation to illuminate a first FOV;
controlling the illuminator to project the light along a second direction of propagation to illuminate a second FOV;
detecting, using a light detector, reflected light received from the first FOV and the second FOV to generate one or more detection outputs for a combined FOV including the first FOV and the second FOV; and
performing at least one of a detection operation or a ranging operation of an object in the combined FOV based on the one or more detection outputs.

19. The method of claim 18, wherein the light comprises a divergent light beam that carries a single pulse; and
wherein the detector comprises an array of sensors.

20. The method of claim 18, wherein the illuminator comprises a polygon having multiple light reflecting surfaces, each light reflecting surface being associated with a FOV; and
wherein the first FOV and the second FOV are illuminated based on rotating the polygon.
